(19) United States
(12) Patent Application Publication
(10) Pub. No.: US 2006/0255232 A1
(43) Pub. Date: Nov. 16, 2006

(54) Suspension support

(75) Inventors: Yoshinori Hishinuma, Osaka (JP); Yosei Kodama, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Toyo Tire & Rubber Co., Ltd., Osaka (JP)

(21) Appl. No.: 11/157,859

(22) Filed: Jun. 22, 2005

(30) Foreign Application Priority Data
Apr. 4, 2005 (JP) 2005-108049

(51) Int. Cl. F16M 13/00

(52) U.S. Cl. 248/550

(57) ABSTRACT

A suspension support capable of reducing remarkably noise ascribable to vibration transmitted from tires to the cabin inside, in particular, noise due to tire cavity resonance is provided, which comprises an inner attachment member to be attached to an upper end portion of a rod of a shock absorber, an outer attachment member surrounding the inner attachment member and to be attached to a car body side, and a vibration-isolating base of rubber-like elastomer interposed between these members. To that end, an actuator as vibration exciting means driven by means of electromagnets is provided and connected to the upper end portion of the rod so as to excite the rod in its axial direction.

### BACKGROUND OF THE INVENTION

1. Field of the Invention

This invention relates to a suspension support as an antivibration device in a suspension for vehicles such as automobiles, etc.

2. Description of the Related Art

In a suspension for automobiles or any other vehicles, for example, a strut type or double wishbone type suspension, a suspension support device having a vibration damping function used at a connecting location of a rod of a shock absorber to the vehicle body side is generally comprised of a cylindrical inner attachment member to be attached to an upper end portion of the rod of the shock absorber, an outer attachment member to be attached to the vehicle body side, and a vibration-isolating base connecting both members over a whole circumference thereof and made of rubber-like elastomer (see, for example, JP Patent Application Publication 2004-278598 A). Such a suspension support as this is installed at the connecting location of the rod of the shock absorber to the vehicle body side member and serves to absorb and mitigate the vibration of the rod of the shock absorber incident to upward and downward oscillations of tires due to traveling of the vehicle by the vibration-isolating base between the inner attachment member and the outer attachment member thereby blocking the transmission of the vibration from the rod to the vehicle body side.

Of late, a silence level required for automobiles, in particular luxury passenger cars has been increasingly higher. For the reduction of noise due to vibration originated from the engine, for example, such a technology is proposed that an actuator is fitted to an engine mount supporting the engine to the car body thereby to generate such an anti-phase controlled vibration that counteracts (negates) the engine vibration thus reducing the noise of a cabin interior (car room)(see, for example, JP Patent Application Publication 6-16047 A).

For further silencing purposes, however, also regarding road noises which are noises caused by vibration transmitted from tires to the cabin interior as well as the vibration from the engine, a reduction of them more than before is required. Of such road noises, the noise ascribable to a tire cavity resonance is noise of a relatively low amplitude that is so harsh on the ears that its reduction is required. According to the conventional type suspension supports as described above, however, a certain degree of vibration suppressing effect to the road noise caused by vibration attributed to irregularities of the road surface, etc. could be obtained, and yet it was unable to exhibit a sufficient reduction effect to the noise due to the tire cavity resonance.

### SUMMARY OF THE INVENTION

In view of the circumstances above, this invention has been accomplished, and it is an object of the invention to provide a suspension support capable of reducing remarkably noise transmitted from the tires to the cabin interior, in particular, the noise due to the tire cavity resonance.

The suspension support of this invention for solving the above-mentioned object comprises a cylindrical inner attachment member to be fitted on an upper end portion of a rod of a shock absorber, an outer attachment member surrounding the inner attachment member and to be fitted on a vehicle body side, and a vibration-isolating base made of rubber-like elastomer interposed between the inner attachment member and the outer attachment member to connect both attachment members; wherein the suspension support is further provided with vibration exciting means driven by means of electromagnets, the vibration exciting means being coupled to the upper end portion of the rod so as to excite the rod in its axial direction.

In this suspension support, the aforesaid vibration exciting means is subjected to drive control so that it may excite the rod in the axial direction to accommodate vibrations of the rod in the axial direction transmitted from the wheels side to the rod, and the vibration exciting means is driven to impart such vibration to the rod that counteracts the vibration of the rod in the axial direction in a predetermined frequency range. Thereby it is possible to reduce the vibration in the predetermined frequency range of the rod in the axial direction transmitted from the tires to the rod, and hence it is possible to reduce noise of the cabin interior due to the aforesaid vibration. Here, since the vibrant sound attributed to the tire cavity resonance is about 200 Hz, it is possible to effectively reduce the cabin noise caused by the cavity resonance by drive controlling the vibration exciting means so as to counteract the vibration in a frequency range ranging from 150 Hz to 250 Hz.

In the suspension support above, the aforesaid vibration exciting means is, more particularly, connected to vibration detecting means for detecting the vibration in a predetermined frequency range of the rod in the axial direction and constructed so that a signal based on the vibration detected by the instrumentality of the vibration detecting means is input and thereby the vibration exciting means may be subjected to drive control, thus imparting such vibration to the rod that counteracts the aforesaid vibration in the predetermined frequency range.

The aforesaid vibration exciting means may be linked rigidly to the upper end portion of the rod, but is preferred to be connected through the intermediary of a shock absorbing member to it. Thereby it is possible to prevent an excessive input from the rod from being transmitted directly to the vibration exciting means, thus avoiding any damage of the vibration exciting means.

The aforesaid vibration exciting means is preferably a moving iron-core type actuator that has a shaft member connected to the upper end portion of the rod, wherein the shaft member is configured at least as a part of a mover capable of reciprocating in the axial direction relative to a stator disposed outside thereof, and that is constructed so that the shaft member may be driven in both directions of a go motion stroke and a return motion stroke to excite the rod by magnetization of a coil provided at the stator.

That is, by employing the moving iron-core type actuator as a vibration exciting means, it is possible to get rid of delay in rising of the force generated by reciprocating motion of the shaft member, so that a rapid and smooth drive control of the mover is possible. Further because of the moving iron-core type, a large output is obtainable without making its outside diameter large.

Preferably, the above-mentioned actuator includes the mover having a magnetic material part attached to the outer periphery of the shaft member, and an annular stator disposed outside the mover, wherein the mover is supported in an internal cavity part of the stator to be capable of reciprocating in the axial direction, the stator has magnetic pole parts projecting radially inwardly that have at least one pair of permanent magnets disposed adjacent to each other in the axial direction and constituting mutually unlike poles and a coil wound around the magnetic pole parts and capable of generating a magnetic flux passing through the pair of permanent magnets; and the actuator is constructed so that the mover can be reciprocated in the axial direction by a combination of magnetomotive force generated by the magnetization of the coil and respective magnetomotive forces of the permanent magnets.

By this construction, it is possible to obtain a large exciting force in spite of a downsized one and hence, it is also possible to carry the invention into effect as a suspension support undergoing a considerably large load without making it very large-sized.

In the above-mentioned suspension support, it is alternatively possible that the aforesaid inner attachment member includes a cylinder member assuming a cylinder shape, through which the upper end portion of the rod inserts and to an outer periphery of which the vibration-isolating base is vulcanization bonded, and a receptive member connected to the upper end face of the cylinder member and receiving the upper end portion of the rod; the aforesaid outer attachment member includes a plate member having a through-hole through which the cylinder member inserts and to be fitted to the lower face side of an opening of the car body and a cup-shaped member attached to a lower face side of the outer periphery of the plate member to form an accommodation space for the vibration-isolating base together with the plate member, there is further provided a housing member that is attached to an upper face side of the opening of the car body to accommodate the vibration exciting means; the stator is fixed to the housing member while the mover is joined to the receptive member projecting upwardly of the opening of the car body.

Thus, the section functioning as an upper support connecting the intermediate between the rod of the shock absorber and the car body side in an antivibratory fashion is installed on the lower face side of the car body opening whereas the vibration exciting means is installed on the upper face side of the car body opening, whereby it is possible to effectively take advantage of the upper space above the car body opening to mount the vibration exciting means, yielding an excellent space efficiency.

According to the suspension support of this invention, it is thus possible to excite the rod in the axial direction by means of the vibration exciting means joined to the upper end portion of the rod, thereby reducing vibrations in a predetermined frequency range and hence, noise ascribable to the vibration transmitted from the tires to the cabin interior, in particular, noise in the cabin originated from tire cavity resonance can be effectively reduced.

### BRIEF DESCRIPTION OF THE DRAWINGS

FIG. 1 is a perspective sectional view of a suspension support in one embodiment of the invention;

FIG. 2 is a longitudinal cross-section of the suspension support above in its state of use;

FIG. 3 is a schematic view of a vehicle assembled with the suspension support above;

FIG. 4 is a schematic explanatory view showing the operation of an actuator;

FIG. 5 is a schematic explanatory view showing the operation of the actuator when flowing a current through a coil in a positive direction;

FIG. 6 is a schematic explanatory view showing the operation of the actuator when flowing a current through the coil in the reverse direction;

FIG. 7 is a block diagram of a noise reduction system employing the above-mentioned suspension support; and

FIG. 8 is a graph showing results of a noise reduction confirmation test.

### DESCRIPTION OF THE PREFERRED EMBODIMENTS

Preferred embodiments of the present invention will be hereinafter described with reference to the accompanying drawings.

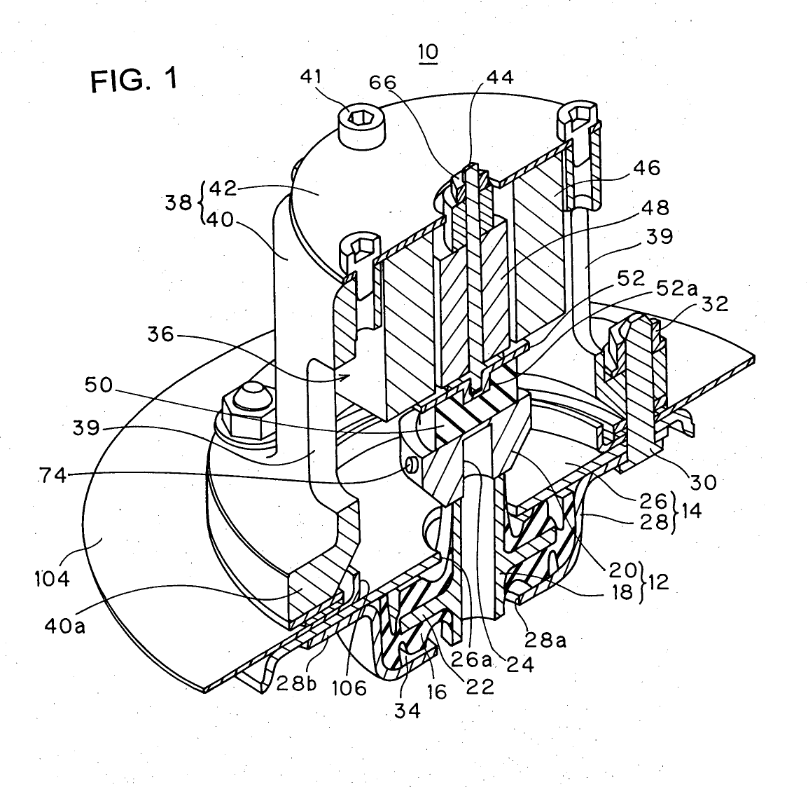

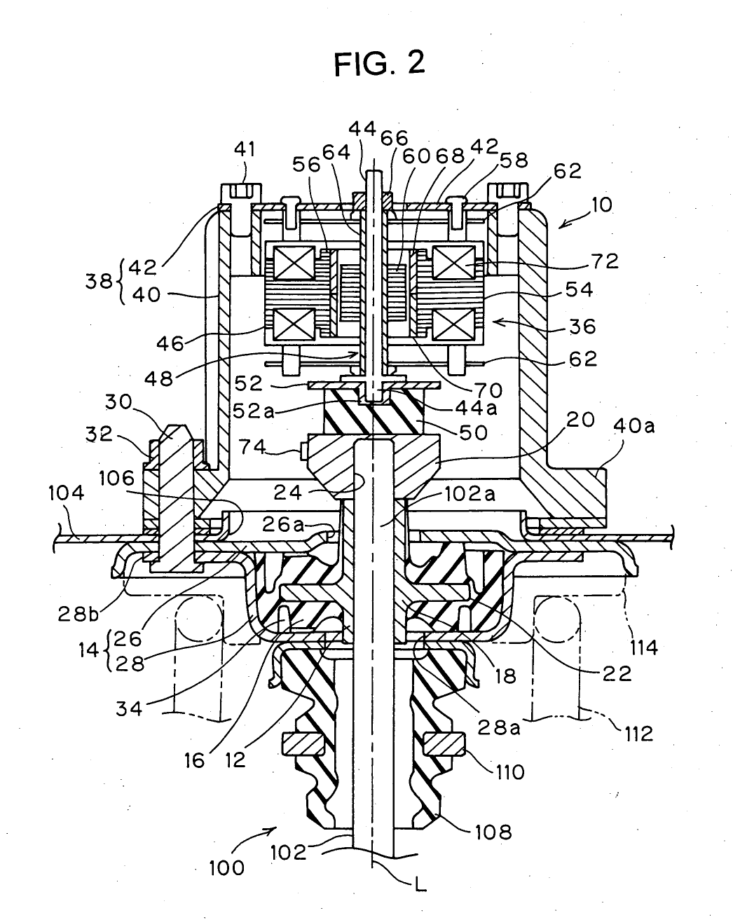

One embodiment of a suspension support pertaining to the invention is shown in FIGS. 1 to 3. The suspension support 10 in this embodiment is an upper support that is provided with a cylindrical inner attachment member 12 to be attached to an upper end portion 102a of a rod 102 of a shock absorber 100, an outer attachment member 14 to be attached to a car body 104, which encompasses a body panel, a frame, and connecting members to these, and a vibration-isolating base 16 interposed between these inner attachment member 12 and the outer attachment member 14 to connect both and made of a rubber-like elastomer. In FIG. 2, the respective reference numerals 108 designate a bound stopper made of rubber; 110 a dynamic damper embedded in the bound stopper; 112 a coil spring of a suspension; and 114 a spring seat for supporting the upper end of the coil spring.

The inner attachment member 12 is made up of a cylinder member 18 made of metal assuming a cylinder shape, through which the upper end portion 102a of the rod inserts, and a receptive member 20 made of metal connected to the upper end face of the cylinder member to receive the upper end portion 102a therein. The cylinder member 18 has a flange portion 22 provided on an outer peripheral face of its axially intermediate part in a manner projecting in the normal direction to its axis. To an outer periphery of the cylinder member 18, the vibration-isolating base 16 is vulcanization bonded so that the flange portion 22 may be embedded in it. The receptive member 20 assumes a generally columnar shape having a recess 25 opening downwardly, within which the upper end portion 102a of the rod is inserted and secured.

The outer attachment member 14 is made up of a disc-shaped plate member 26 made of metal attached to a circular opening 106 of the car body 104 for attachment so as to close the opening from its underside, and a cup-shaped member 28 made of metal attached to the underside of the plate member 26 at its outer peripheral portion. The plate member 26 is defined, in its central area, with a through-hole 26a, through which the cylinder member 18 inserts and attached and secured, at an outer periphery thereof, to the underside of a marginal portion of the car body opening 106 with a bolt 30 and a nut 32. The cup-shaped member 28 assumes an upwardly opening vessel shape and is defined in its bottom wall center with a through-hole 28a, through which the rod 102 is inserted. Further the cup-shaped member 28 is formed, at an opening margin of its upper end, as a flange portion 28b extending outwardly, which is superposed on the outer peripheral portion of the plate member 26 and fixed with the bolt 30 and the nut 32. And by combining the plate member 26 and the cup-shaped member 28 in this manner, an accommodation space 34 for the vibration-isolating base 16 is defined between the both. The in-between of the inner attachment member 12 and the outer attachment member 14 is thus joined elastically through the vibration-isolating base 16 by accommodating the vibration-isolating base 16 in the accommodation space 34.

In the suspension support 10 thus fundamentally constructed, in this embodiment, a linear actuator 36 (hereinafter simply referred to as “actuator”) as a vibration exciting means driven by means of electromagnets is provided. The actuator 36 is coupled to the upper end portion 102a of the rod through the intermediary of the inner attachment member 12 so as to excite the rod 102 in its axial direction L. In particular, in this embodiment, the actuator 36 is controlled electrically on the basis of the vibration in the axial direction L transmitted from a tire 116 to the rod 102 and constructed so as to impart a vibration accommodating to the aforesaid vibration in the axial direction to the rod 102.

The actuator 36 is accommodated in a housing member 38 fitted on the upper face side of the car body opening 106. The housing member 38 includes a cylindrical main body 40 and a top plate part 42 secured to the main body 40 with a bolt 41 so as to dose an upper end opening thereof so that a flange portion 40a of the main body 40 extending outwardly at its lower end may be secured to the car body 104 together with the plate member 26 and the cup-shaped member 28 with the bolt 30 and the nut 32. The reference numeral 39 designates a window provided at the main body 40, and the windows 39 are provided at the main body diametrically opposite to each other.

A variety of linear actuators driven by means of electromagnets in the axial direction may be utilized as a vibration exciting means, but a so-called moving iron-core type actuator 36 is used particularly advantageously, which has a shaft member 44 connected to the upper end portion 102a of the rod as shown in FIG. 2, wherein the shaft member 44 is constructed at least as a part of a mover 48 capable of reciprocating in the axial direction relative to a stator 46 disposed outside the shaft member 44.

The shaft member 44 is provided above the upper end portion 102a of the rod in a longitudinal posture concentric with its axis center and secured at its lower end 44a to the receptive member 20 protruding upwardly of the car body opening 106, thereby being connected to the upper end portion 102a of the rod. In this embodiment, the shaft member 44 is connected through a shock absorbing member 50 to the upper end portion 102a of the rod. The shock absorbing member 50 is a columnar rubber member. To the underside of the shock absorbing member 50, an upside of the receptive member 20 is vulcanization bonded while to the upside thereof, a metal plate 51 is vulcanization bonded. The metal plate 52 is defined with a recess 52a, in which the lower end 44a is fitted and fixed.

The actuator 36 has the stator 46 to be fixed to the car body 104 side and the mover 48 supported in an internal cavity part (axis center part) of the stator 46 so as to be capable of reciprocating in the axial direction relative to the stator 46.

The stator 46 is situated outside the mover 48, and has a yoke 54 that is constructed of a multitude of annular (mainly a polygonal annular shape) metal plates laminated one another and made of magnetic metal such as an electromagnetic sheet steel and magnetic pole parts 56, 56 protruding toward radially inwardly from both sides so as to mutually oppose, interposing the mover 48 in a central part of the yoke 54. The stator 46 is fastened and fixed at its outer peripheral part to the underside of the top plate part 42 with bolts 58.

The mover 48 includes the shaft member 44 in the middle and a magnetic material part 60 as a mover iron core, which is formed of a multitude of magnetic metal plates laminated together similar to the above, secured to the shaft member 44 in an axially intermediate part thereof. The shaft member 44 is connected through a pair of upper and lower leaf springs 62, 62 so as to be capable of reciprocating in the vertical direction (axial direction of the shaft member 44) to the stator 46, thereby being supported. With the illustrated example, the magnetic material part 60 is fixed to a pipe member 64, which is in turn fitted fixedly in the outer periphery of the shaft member 44. To the pipe member 64, a pair of the leaf springs 62, 62 are secured to be spaced apart from each other above and beneath the magnetic material part 60. The pipe member 64 is fixed to the shaft member 44 in a positioning state in its axial direction by fastening the upper end portion of the shaft member 44 with a nut 66. The top plate part 42 of the housing member 38 is defined in its central area with an opening through which the nut 66 can pass.

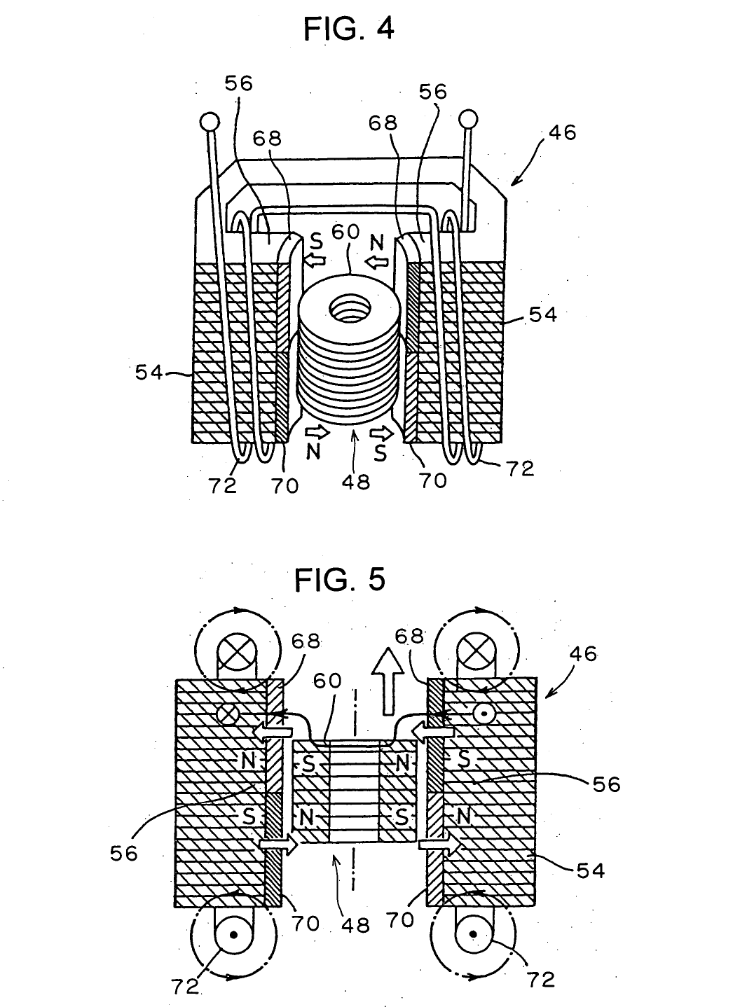

Also as shown in FIGS. 4 through 6, the magnetic pole parts 56, 56 of the stator 46 opposing the magnetic material part 60 of the mover 48 are provided at their extremities, namely at internal extremities with a pair of upper and lower arc plate-like permanent magnets 68, 70 that are arranged adjacently in the reciprocating direction (the vertical direction) of the mover 48 and oppose the magnetic material part 60. And the permanent magnets 68, 70 are disposed so that their magnetic poles may be arranged to constitute mutually N-S alternating unlike poles in the orthogonal direction to the reciprocating direction (the lateral direction) and orientations of the magnetic poles (N pole and S pole) of them are inverse. The length from the top end of the upper permanent magnet 68 to the lower end of the lower permanent magnet 70 is longer than the length of the magnetic material part 60 in the vertical direction (axis center direction).

And a coil 72 is wound around the magnetic pole parts 56 of the stator 46, namely around the axis center of the orthogonal direction to the reciprocating direction (in the lateral direction in FIG. 2) so that a magnetic flux passing through the pair of permanent magnets 68,70 can be generated.

In the example as shown, one pair of the permanent magnets 68, 70 are provided at the internal extremities of the two magnetic pole parts 56, 56 of the stator 46 mutually facing and interposing the mover 48 therebetween. The permanent magnets 68, 70 on the respective magnetic pole parts 56, 56 thus oppose in the orthogonal direction to the reciprocating direction, interposing the magnetic material part 60 between them, and the opposing magnetic poles of them are oriented in a laterally inverse state so as to constitute mutually unlike poles. In conformity with this, the respective coils 72 are wound around the magnetic pole parts 56, 56 in the state that they are located outwardly of the respective permanent magnets.

As shown in FIG. 4, the one pair of coils 72, 72 are mutually linked. In this embodiment as shown in FIGS. 4 and 5, of the pair of the upper and lower permanent magnets 68, 70 at the right hand, the upper permanent magnet 68 has N pole on its face opposing the magnetic material part 60 and S pole on the opposite face side, whereas the lower permanent magnet 70 has S pole on its face opposing the magnetic material part 60 and N pole on the opposite face side. In FIGS. 4 and 5, voided arrow marks oriented in the lateral direction indicate orientations of magnetomotive force of the permanent magnets 68, 70. The magnetomotive force orients to the left hand at the upper one and to the right hand at the lower one.

By the construction as described above, when no current is supplied to the coil 72, the magnetic flux due to the permanent magnets 68, 70 on the magnetic pole parts 56, 56 at the right and left hands is short-circuited through the magnetic material part 60 opposing both the magnets. And when a positive current is passed through the coil 72 as shown in FIG. 5, the magnetomotive force in the arrow direction is generated to the coil 72, as a result of which the orientation of the magnetomotive force of the upper permanent magnet 68 and the orientation (the arrow mark in FIG. 5) of the magnetomotive force of the coil 72 coincide, whereby the magnetic fluxes of the magnets are compounded and the magnetomotive forces are intensified, whereas the orientation of the magnetomotive force of the lower permanent magnet 70 and the orientation of the magnetomofive force of the coil 72 are opposite to each other, whereby both magnetomotive forces are counterbalanced and weakened. As a result, an upwardly oriented force (indicated in the voided arrow mark) acts on the magnetic material part 60 and the shaft member 44 of the mover 48, and the shaft member 44 ascends.

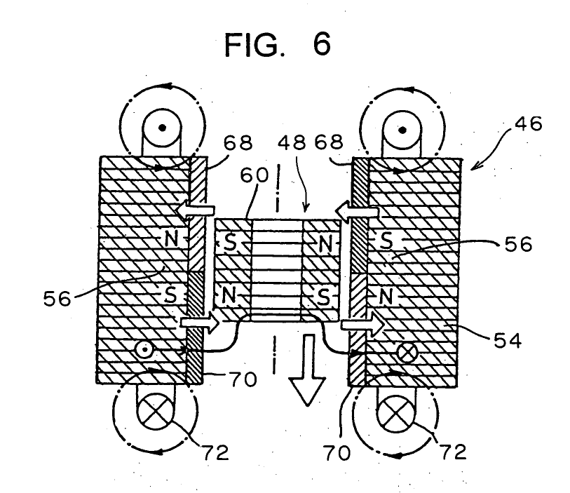

When a current in the reverse direction (negative current) is flowed through the coil 72 as shown in FIG. 6, inversely to the previous case, the orientation of the magnetomotive force of the upper permanent magnet 68 and the orientation of the magnetomotive force of the coil 72 are opposite to each other, and the magnetic fluxes are counterbalanced to weaken the magnetomotive forces whereas the orientation of the magnetomotive force of the lower permanent magnet 70 and the orientation of the magnetomotive force of the coil 72 coincide, and the magnetic fluxes of the magnets are compounded to intensify the magnetomotive forces. Thereby a downwardly oriented force (indicated in the voided arrow mark) acts on the magnetic material part 60 and the shaft member 44 of the mover 48, and the shaft member 44 descends. Thus the direction of the current of the coil 72 is altered alternately between the positive and reverse directions, whereby the shaft member 44 reciprocates up and down.

As a consequence, the moving iron-core type actuator 36 described above can move the shaft member 44 upwardly or downwardly by flowing a sinusoidal wave alternating current through the coil 72 and accordingly, can impart a sinusoidal curve oscillation to the upper end portion 102a of the rod connected to the shaft member 44. Further by controlling the current flowing through the coil 72, it is possible to control the oscillating condition, thereby controlling arbitrarily the oscillation imparted to the upper end portion 102a of the rod.

The following description is made of the construction of a system for reducing noise of the cabin interior by use of the suspension support 10 described above.

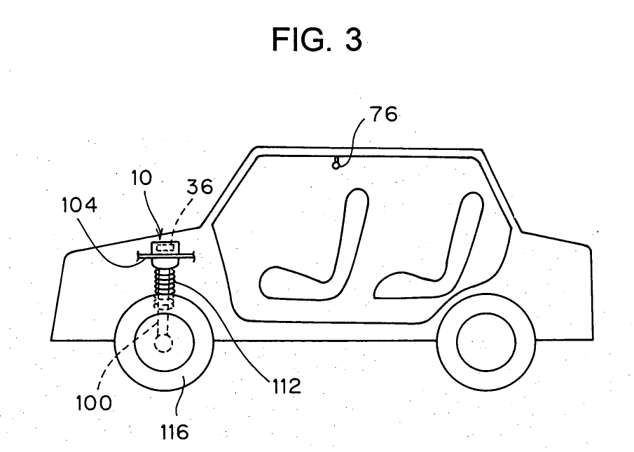

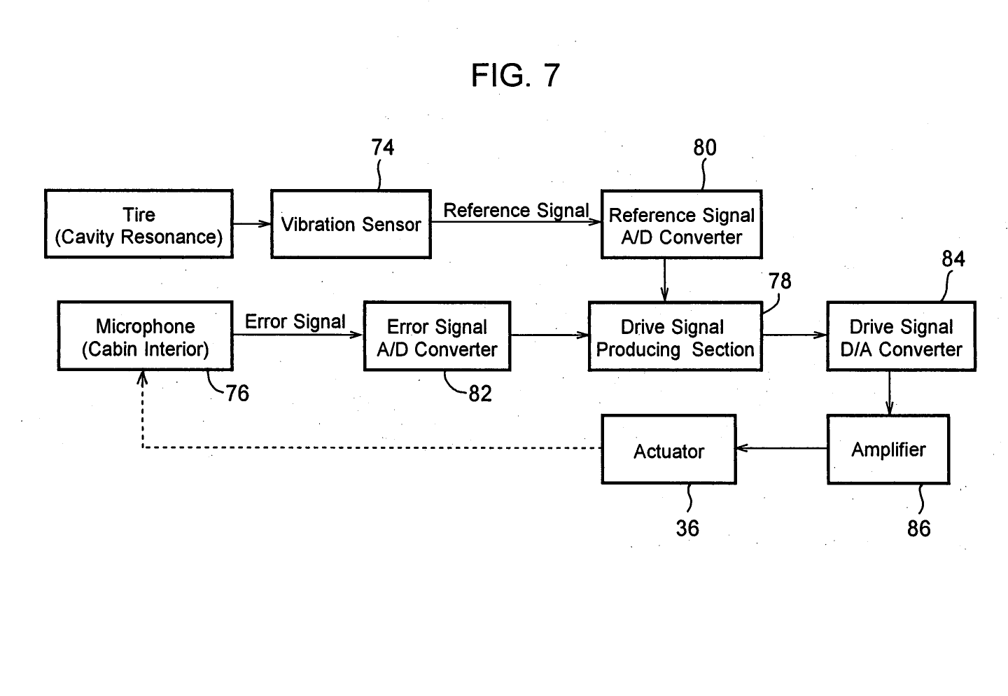

This system is, as shown in FIGS. 3 and 7, made up of the suspension support 10 equipped with the actuator 36 as vibration exciting means, a vibration sensor (acceleration sensor) 74 as a vibration detecting means for detecting vibration in the axial direction of the rod 102, a microphone 76 as a sound detecting means detecting sound in the cabin, and a drive signal producing section 78 for drive controlling the actuator 36 on the basis of a signal from the vibration sensor 74 and the microphone 76.

The vibration sensor 74 is, as shown in FIGS. 1 and 2, fitted to the side face of the receptive member 20 and constructed so as to detect a vibration in a predetermined frequency range (more particularly, 150 to 250 Hz) of the rod in the axial direction to output the vibration as a reference signal. The vibration sensor 74 is connected to a reference signal A/D converter 80 which serves to convert the reference signal from analog value to digital value.

The drive signal producing section 78 is connected to the reference signal A/D converter 80 and an error signal A/D converter 82 so as to produce a drive signal for drive controlling the actuator 36 on the basis of digital signals input from those, and constructed of a digital signal processor (DSP) known per se. At the drive signal producing section 78, in order to input a signal giving the rod 102 such a waveform vibration into the actuator 36 that counteracts the axial vibration in a predetermined frequency range of the rod 102 (vibration of the same amplitude in anti-phase) by driving of the actuator 36, a drive signal is produced on the basis of the reference signal and the error signal. The signal like this can be produced by preliminarily inputting a random signal into the actuator 36 to measure the error signal thereby obtaining a transfer function of the system.

The drive signal output from the drive signal producing section 78 is converted on the drive signal D/A (digital-to-analog) converter 84 to an analog signal and further amplified for driving of the actuator (for example, 100- to 200-fold) on an amplifier 86 such as a power amplifier, followed by inputting into the stator 46 of the actuator 36.

Thereby the mover 48 of the actuator 48 is drive-controlled and a vibration counteracting the axial vibration in the predetermined frequency range of the rod 102 is imparted to the rod 102 and hence, it is possible to reduce vibrations in the predetermined frequency range of the rod 102 in the axial direction transmitted from the fire 116 to the rod and accordingly, to reduce noise in the cabin interior ascribable to the aforesaid vibrations. In particular, by drive controlling the actuator 36 so as to counteract the vibration in a frequency range of 150 to 250 Hz, the noise of the cabin interior attributed to void resonance can be effectively reduced.

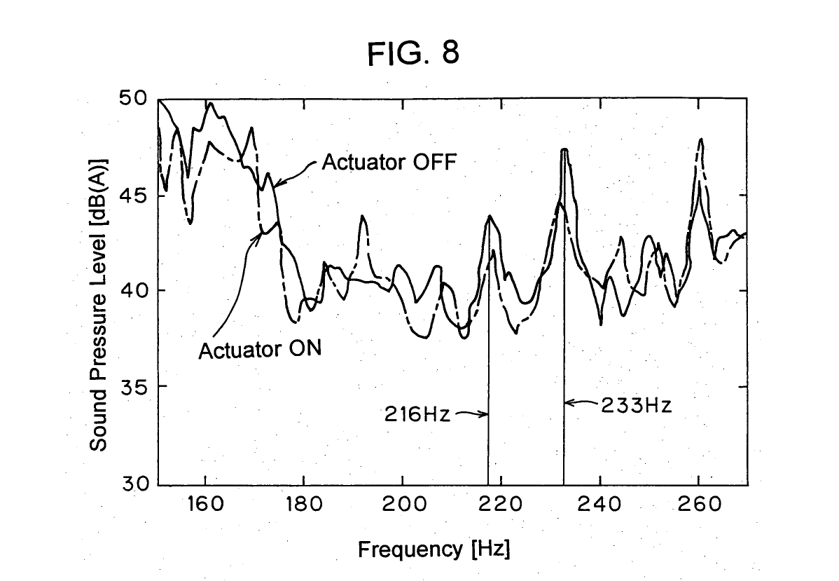

In order to corroborate this operation and effect, the suspension support 10 was mounted on a passenger car as shown in FIGS. 2 and 3, and a noise reduction confirmation test of the car was carried out in the field by detecting acceleration speed of the rod 102 in the axial direction by means of the vibration sensor 74 and simultaneously detecting sound of the cabin interior by means of the microphone 76. At that time, a frequency range of 150 to 250 Hz was chosen, and sound pressure level of the cabin interior was measured both in the case where the actuator 36 is subjected to drive control by a drive signal from the drive signal producing section 78 (actuator ON) and the non-controlled case (actuator OFF). The results obtained are as shown in FIG. 8. As is dear from it, by the drive controlling of the actuator 36, the noise attributed to cavity resonance in the vicinity of 216 Hz and in the vicinity of 233 Hz was reduced and in particular, the noise in the vicinity of 233 Hz was reduced by 2.7 dB in comparison with the non-controlled case.

According to the suspension support 10 in this embodiment, due to a combination of the magnetomotive forces in respective orientations of a pair of the permanent magnets 68, 70 constituting mutually unlike poles and the magnetomotive force generated in the coil 72, a larger output than in a moving magnet type device is available, despite a relatively compact device.

Furthermore, since the mover 48 of the actuator is connected to the upper end portion 102a of the rod through the intermediary of the shock absorbing member 50, it is possible to prevent an excessive input from the rod 102 from being directly transmitted to the actuator 36, thereby avoiding damage of it.

The present invention can be particularly advantageously utilized in a strut type or double wishbone type suspension of a vehicle for automobiles, etc.

1. A suspension support comprising:
a cylindrical inner attachment member to be attached to an upper end portion of a rod of a shock absorber,
an outer attachment member surrounding the inner attachment member and to be attached to a vehicle body side, and
a vibration-isolating base made of rubber-like elastomer interposed between the inner attachment member and the outer attachment member to connect both attachment members;
which further comprises vibration exciting means driven by means of electromagnets,
the vibration exciting means being coupled to the upper end portion of said rod so as to excite the rod in its axial direction.

2. The suspension support as set forth in claim 1, wherein said vibration exciting means is subjected to drive control so as to excite the rod in the axial direction to accommodate vibrations of the rod in the axial direction that are transmitted from wheels side to the rod.

3. The suspension support as set forth in claim 2, wherein said vibration exciting means is connected to vibration detecting means for detecting vibration in a predetermined frequency range of the rod in the axial direction and constructed so as to be subjected to drive control by inputting of a signal based on the vibration detected by means of the vibration detecting means thereby to impart such vibration to the rod that counteracts the vibration of the rod in the predetermined frequency range.

4. The suspension support as set forth in claim 1, wherein said vibration exciting means is connected to the upper end portion of the rod through a shock absorbing member.

5. The suspension support as set forth in claim 1, wherein said vibration exciting means is a moving iron-core-type actuator that has a shaft member connected to the upper end portion of the rod, the shaft member being constructed at least as a part of a mover capable of reciprocating in its axial direction relative to a stator disposed outwards of the shaft member;
and is constructed so that by magnetization of a coil provided at the stator, the shaft member may be driven in both directions of its go motion stroke and return motion stroke to excite the rod.

6. The suspension support as set forth in claim 5, wherein said actuator comprises:
the mover equipped with a magnetic material part at an outer periphery of the shaft member, and
the stator in an annular form disposed outside the mover;
said mover being supported in an internal cavity of the stator to be capable of reciprocating in the axial direction,
said stator having magnetic pole parts projecting radially inwardly thereof,
said magnetic pole parts being provided each with at least one pair of permanent magnets that are adjacent to each other in the axial direction to constitute mutually unlike poles,
and a coil wound around the magnetic pole parts and capable of generating a magnetic flux passing through said pair of the permanent magnets;
and said actuator is constructed so that the mover is reciprocated in the axial direction by a combination of magnetomotive force generated by magnetization of the coil and respective magnetomotive forces of the permanent magnets.

7. The suspension support as set forth in claim 5, wherein said inner attachment member includes
a cylinder member assuming a cylinder shape, through which the upper end portion of the rod passes and to an outer peripheral part of which said vibration-isolating base is vulcanization bonded, and a receptive member connected to an upper end face of the cylinder member and receiving the upper end portion of the rod;
said outer attachment member includes a plate member having a through-hole, through which the cylinder member is inserted and adapted to be fitted to a lower face side of an opening of a car body,
and a cup-shaped member attached to an underside of an outer peripheral portion of the plate member to define a space accommodating the vibration-isolating base together with the plate member;
there is further provided a housing member that is adapted to be attached to an upper face side of the opening of the car body to accommodate the vibration exciting means, wherein the stator is fixed to the housing member and the mover is connected to the receptive member protruding upwardly from the opening of the car body.
